(19) United States
(12) Patent Application Publication
(10) Pub. No.: US 2021/0107355 A1
(43) Pub. Date: Apr. 15, 2021

(54) VEHICLE STEERING WHEEL INPUT MECHANISM FOR CONFIGURING VEHICLE OUTPUT DISPLAY

(71) Applicant: SF Motors, Inc., Santa Clara, CA (US)

(72) Inventors: Jo Ann Galor Sison, Santa Clara, CA (US); Michelle De Demo, Santa Clara, CA (US)

(73) Assignee: SF Motors, Inc., Santa Clara, CA (US)

(21) Appl. No.: 16/600,852

(22) Filed: Oct. 14, 2019

(51) Int. Cl. B60K 35/00; B62D 1/06

(52) U.S. Cl. CPC B60K 35/00; B62D 1/06; B60K 2370/143; B60K 2370/167; B60K 2370/151; B60K 2370/178; B60K 2370/169; B60K 2370/166; B60K 2370/171

(57) ABSTRACT

A vehicle steering wheel input mechanism for configuring vehicle output displays. The steering wheel input mechanism can include “forced touch” pressure sensitive areas which serve as an input mechanism for selecting information to visualize on vehicle output displays, such as for example navigation maps or advance driver-assistance systems (ADAS) visualizations. Different levels of information can be provided in response different levels of force applied by a driver (e.g., user) to the steering wheel input mechanism. A vehicle with the present steering wheel input mechanism provides a user with an easy-to-activate and intuitive means to “drill down” and see additional information about their surroundings by varying the firmness (e.g. soft/medium/firm) of pressure applied the steering wheel input mechanisms.

### SUMMARY

The present technology, roughly described, provides a vehicle steering wheel input mechanism for configuring vehicle output displays. The steering wheel input mechanism can include “forced touch” pressure sensitive areas which serve as an input mechanism for selecting information to visualize on vehicle output displays, such as for example navigation maps or advance driver-assistance systems (ADAS) visualizations. Different levels of information can be provided in response different levels of force applied by a driver (e.g., user) to the steering wheel input mechanism. A vehicle with the present steering wheel input mechanism provides a user with an easy-to-activate and intuitive means to “drill down” and see additional information about their surroundings by varying the firmness (e.g. soft/medium/firm) of pressure applied the steering wheel input mechanisms.

In some instances, a vehicle steering wheel input mechanism for configuring an output on a vehicle display includes a steering wheel, an input mechanism on the steering wheel of a vehicle, and a data processing system. The data processing system receives input from the input mechanism and provides an output through a display of the vehicle. The data processing system performs operations to receive a first input initiated from a user through the input mechanism on the steering wheel of the vehicle, the input mechanism having a plurality of input levels, wherein each input level is associated with a different pressure being applied to the surface of the input mechanism on the steering level, the first input received as a first pressure corresponding to the first input level, identifying a subject to provide information through a display, provides a first set of content regarding the identified subject through the display, receives a second input from the user through the input mechanism on the steering wheel of the vehicle, the second input received as a second pressure corresponding to the second input level, and provides a second set of content regarding the identified subject through the display.

In some instances, a method configures an output display of a vehicle using input received from a vehicle steering wheel input mechanism. The method includes receiving a first input from a user through an input mechanism on a steering wheel of a vehicle, the input mechanism having a plurality of input levels, wherein each input level is associated with a different pressure being applied to the surface of the input mechanism on the steering level, the first input received as a first pressure corresponding to the first input level, identifying a subject to provide information through a display, providing a first set of content regarding the identified subject through the display, receiving a second input from the user through the input mechanism on the steering wheel of the vehicle, the second input received as a second pressure corresponding to the second input level, and providing a second set of content regarding the identified subject through the display.

### BRIEF DESCRIPTION OF FIGURES

FIG. 1 is an autonomous vehicle display system having vehicle steering wheel input mechanisms.

FIG. 2 illustrates a vehicle steering wheel having a plurality of multilevel touch input mechanisms.

FIG. 3 illustrates a vehicle steering wheel having multilevel touch input mechanism around an outer surface of the steering wheel.

FIG. 4 illustrates a vehicle steering wheel having an input mechanism on the outer surface of the inner portion of the steering wheel.

FIG. 5 illustrates a method for providing information to a driver of a vehicle based on an input from a vehicle steering wheel.

FIG. 6 illustrates a method for providing output based on a detected pressure input double from a steering wheel input mechanism.

FIG. 7 illustrates a method for determining display content for a vehicle display.

FIG. 8 illustrates a display providing a first level of information in response to receiving a first level of input at a steering wheel from a user.

FIG. 9 illustrates a display providing a second level of information in response to receiving a second level of input at a steering wheel from a user.

FIG. 10 illustrates a display providing a third level of information in response to receiving a third level of input at a steering wheel from a user.

FIG. 11 is a block diagram of systems comprising an autonomous vehicle.

FIG. 12 is a block diagram of a computing environment.

### DETAILED DESCRIPTION

The present technology, roughly described, provides a vehicle steering wheel input mechanism for configuring vehicle output displays. The steering wheel input mechanism can include “forced touch” pressure sensitive areas which serve as an input mechanism for selecting information to visualize on vehicle output displays, such as for example navigation maps or advance driver-assistance systems (ADAS) visualizations. Different levels of information can be provided in response to different levels of force applied by a driver (e.g., user) to the steering wheel input mechanism. A vehicle with the present steering wheel input mechanism provides a user with an easy-to-activate and intuitive means to “drill down” and see additional information about their surroundings by varying the firmness (e.g. soft/medium/firm) of pressure applied the steering wheel input mechanisms.

In some instances, the touch and/or pressure information from the driver can be used to potentially identify the individual based on individual touch and/or pressure characteristics, such as pressure, surface area, grip pattern, and so on.

When a driver is operating a vehicle having the steering wheel input mechanism, an output display may initially provide an initial or default map view. As a user progressively applies more pressure of forced touch to portions of the steering wheel having the input mechanism, the increased force serves as an input, the input is processed by a data processing system on-board the vehicle, and more information is provided by the vehicle output device. The information layers shown in response the user input can either be self-selected by the driver or selected by the system according the driving context (e.g. in an electric vehicle low on charge, the system could adapt to show charge station on the map with medium squeeze, and more detailed info about specific charge station availability could be shown with a firm squeeze) In another example, when the vehicle is close to the end of a selected route, and the driver likely needs to find parking, the system can adapt to show parking garages with a medium squeeze, and specific garage availability/price with a firm squeeze.

Examples of the present technology are discussed with reference to an autonomous vehicle. Such references are intended to be exemplary, and the present technology can be used in autonomous and non-autonomous vehicles.

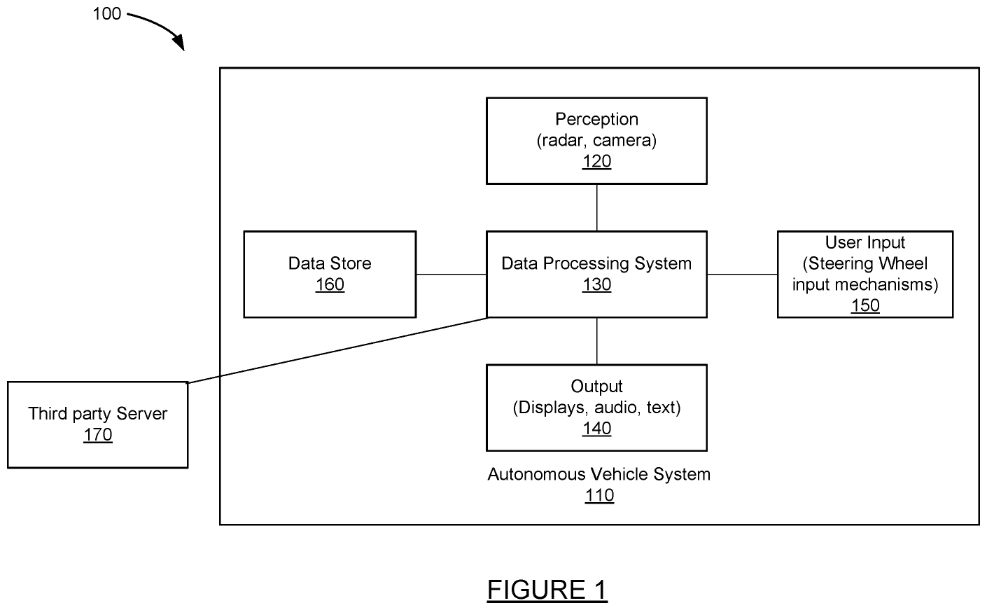

FIG. 1 is an autonomous vehicle display system having vehicle steering wheel input mechanisms. The system 100 of FIG. 1 includes autonomous vehicle system 110 and third-party server 170. Autonomous vehicle system 110 includes perception 120, data processing system 130, output 140, user input 150, and data store 160. Perception 120 may include various devices that may collect data related to the environment of the vehicle. The perception devices may include radar components, lidar components, ultrasound components, cameras, and other devices. Each module and/or device of perception 120 may capture data and send the data, either in raw or processed form, to data processing system 130.

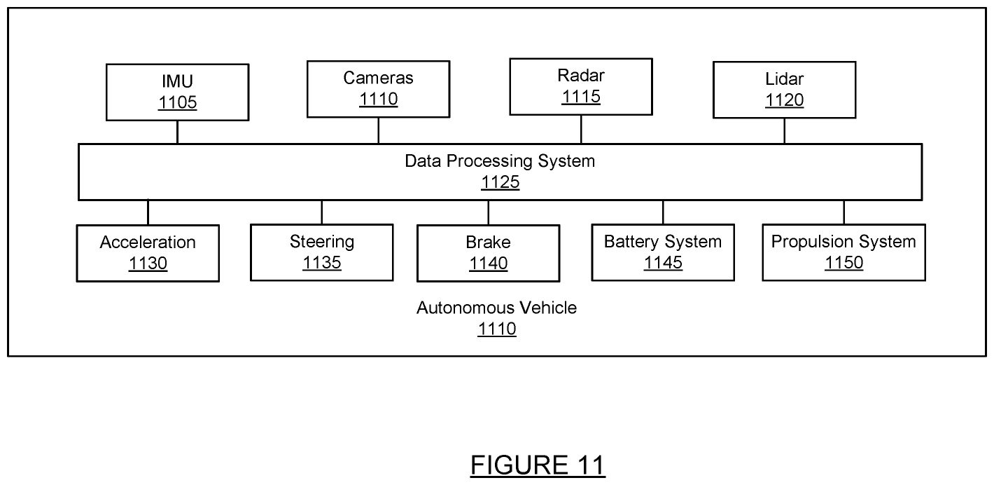

Data processing system 130 may receive data from perception 120, user input 150, data store 160, and third-party server 170, and process the data to generate an output 140. The output may be provided on an ADAS system within a vehicle, as an augmented reality display on the windshield, a rear or side mirror, window, or other portions of the vehicle. Data processing system 130 is discussed in more detail with respect to FIG. 11.

Data store 160 may include graphic data, geographical data, user display and output preference data, and other data that may be utilized by data processing system 130 to provide an output or process data.

User input 150 may include one or more input mechanisms for receiving input from a user. User input 150 may include steering wheel input mechanisms that can receive and differentiate between multiple levels of pressure. Examples of steering wheel input mechanisms may include multilevel touch buttons on a steering wheel, a conductive fabric, material made of at least in part from conductive strands or ribbons, or some other input mechanism. In some instances, the input device includes material that covers the outer surface of a portion of the steering wheel, such as an upper portion or half of the outer portion of a steering wheel.

In some instances, the user input may include mechanisms used to identify the driver. For example, some input surfaces, such as capacitive surfaces, can be used capture fingerprints and thus be used for identification purposes. Once identified, the present system can personalize inputs specific to individuals identified by the system. The system can customize the driver's steering wheel visualization with preferences specific to the user. Further, it could also customize other infotainment and vehicle system preferences, like seat position, radio presets, and other vehicle systems.

In some instances, the present system may utilize a, hand grip measurement or hand dimension measurement to identify the user. In some instances, the steering wheel may incorporate finger vein imaging as a recognition method to identify a user. In some instances, the grip/hand size/fingerprint data from the user could also be used in conjunction with other biometric data to more conclusively identify the user

In some instances, grip strength is also a measure of physical strength/health for older users, so could be used as an indicator of fatigue or tiredness, which in turn could differentially tune the responsiveness of ADAS alerts and other information to driver

Third-party server 170 may communicate with data processing system 130. The communication may include providing geographical data, such as global positioning system data, the data processing system 130, vehicle system updates, or communication of other data.

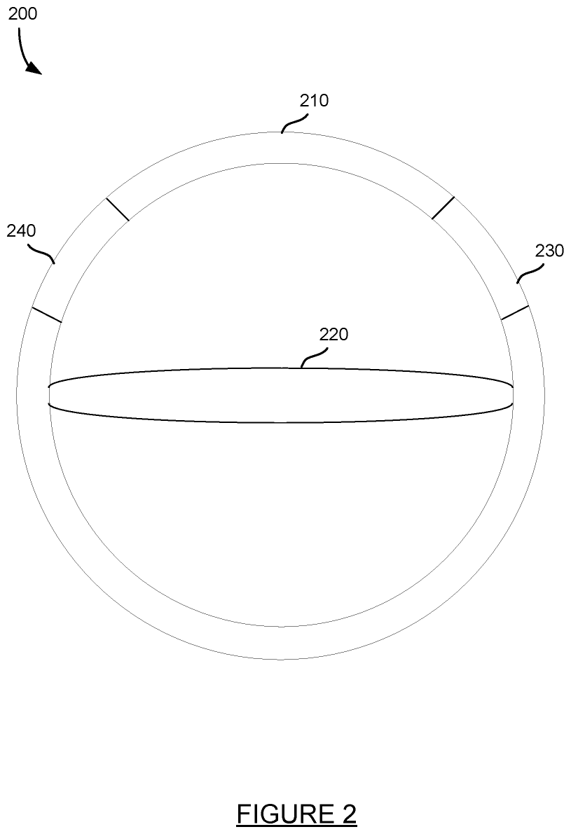

FIG. 2 illustrates a vehicle steering wheel having a plurality of multilevel touch input mechanisms. Steering module 200 includes an outer portion 210 having a roughly circular shape and a steering wheel inner portion 220. Outer portion 210 has an outer surface extending around the entire perimeter of the steering wheel. The outer portion 210 outer surface has a front portion that faces a driver and a back portion that faces away from the driver of a vehicle. Inner steering wheel portion 220 also has a front outer surface that faces a driver and a back outer surface that faces away from the driver.

Outer portion 210 of the steering wheel may include one or more input mechanisms 230 and 240. Each input mechanism 230-240 may receive a pressurized input from a driver (e.g., user) to the surface of the input mechanism. The input mechanism allows a user to provide multiple levels of pressure, each corresponding to a different input value. For example, for an input mechanism that recognizes three levels of pressure input, merely touching the outer surface of mechanism 230 may be a first input, lightly pressing down on the surface of mechanism 230 may provide a second input, and firmly pressing on the surface of mechanism 230 may provide a third input. Steering wheel 200 may include any number of input mechanisms 230 and/or 240, positioned anywhere on the outer portion 210 of steering wheel 200. In some instances, input mechanisms may be placed on the inner portion 220 of steering wheel 200, either on the front or the back, in addition to or in place of input mechanisms on the outer portion 210.

The multilevel input mechanisms 230 and 240 may be any suitable input mechanism, including an input utilizing resistive technology or capacitive technology. When implemented as a resistive technology, multiple layers within the input mechanism can be used to detect when and where an upper layer touches a lower layer to complete an electronic circuit. When implemented using capacitive technology, a conductivity level of a driver can be detected at different points of the input mechanism. These and other types of input mechanisms may be used to implement one or more button, plate, or other input mechanisms on the steering wheel outer portion, inner portion, or both the inner and outer portions.

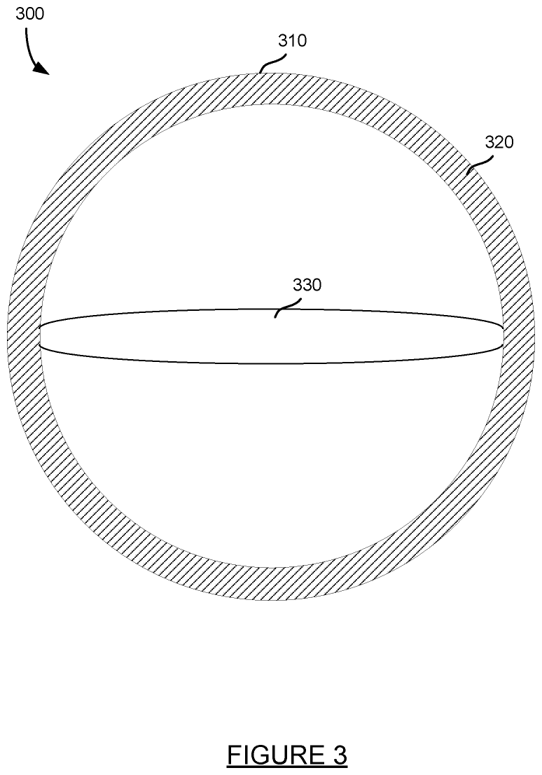

FIG. 3 illustrates a vehicle steering wheel having multilevel touch input mechanism on the surface of an outer portion of the steering wheel. Steering wheel 300 has an outer portion 310 and an inner portion 330. Located on outer portion 310 is a conductive fabric 320. The conductive fabric may be placed around portions of the outer portion, such as an upper half or lower half of the circumference of the outer portion 310, or the entire surface area of the outer portion 310. The conductive fabric may operate to detect different pressures applied by the hands or fingers of the user to the conductive fabric, forming an input in response to the level of the pressure. For example, just lightly pressing the surface of the conductive fabric may provide a first input, providing additional pressure on the surface of the conductive fabric may provide a second input, and pressing firmly on the surface of the conductive fabric may provide a third input. The conductive fabric may contain one more layers of conductive strands, conductive ribbon, conductive thread, or other conductive material weaved, positioned, and/or aligned such that the conductive fabric is able to receive and differentiate between multiple levels of input.

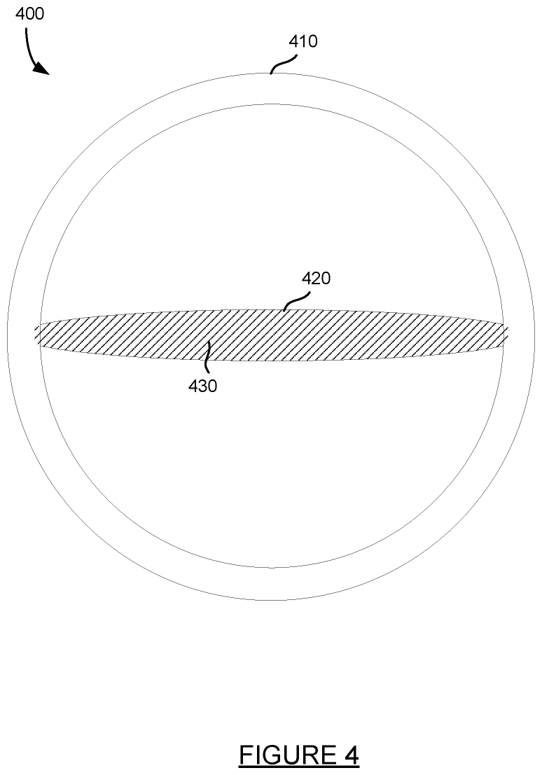

FIG. 4 illustrates a vehicle steering wheel having an input mechanism on the outer surface of the inner portion of the steering wheel. Vehicle steering wheel 400 of FIG. 4 includes an outer portion 410 and an inner portion 420. Inner portion 420 includes a touch input mechanism 430 on the outer surface of the inner portion. Similar to the input mechanism 320 of the steering wheel of FIG. 3, the input mechanism 430 may allow a user to provide input at multiple levels of pressure. For example, by simply touching the surface of the input mechanism 430, a first input may be provided. By lightly pressing on input mechanism 430 on the outer surface of inner portion 420, a second input may be provided. By pressing firmly on input mechanism 430, a third input may be provided. The multilevel touch input mechanism 430 may be implemented as a resistive technology input, a capacitive technology input, or some other input technology. In some instances, the input on the outer surface of the inner portion of steering wheel may be implemented with a conductive fabric that incorporates conductive threading, conductive ribbons, conductive wires, or some other conductive materials in an arrangement, such as a weaving or interleaving, that enables detection of multiple levels of touch input.

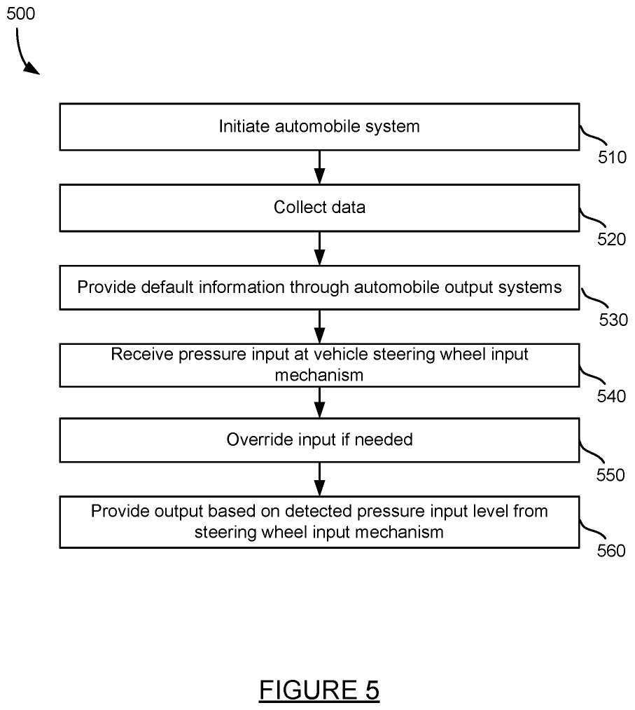

FIG. 5 illustrates a method for providing information to a driver of a vehicle based on an input from a vehicle steering wheel. First, an automobile system may be initialized at step 510. Initialization can include calibrating input mechanisms, receiving initial input from perception sensors and performing initial processing of the perception data, loading values and configuring the vehicle per current driver preferences, and other operations.

Data is collected at step 520. The data may be collected as perception data captured by one or more sensors, data received from a third-party server such as geographical or road data, and other data. Default information may be provided to the user through an automobile output system at step 530. In some instances, the default information may include vehicles on the road in the vicinity of the current vehicle, the current speed of the present vehicle, the amount of gas left in the vehicle, information on a current route being traveled by the vehicle, and other/or information. The default information may be set by a manufacturer or set by user preference. The default data may be output through a display system, such as an in-vehicle display, an ADAS system, as an augmented reality display on a vehicle mirror, window, or windshield, or some other display mechanism within a vehicle.

A pressure input is received at a vehicle steering wheel input mechanism at step 540. The pressure input may be received as one of a plurality of detectable pressure input levels on an input mechanism of the steering wheel. In some instances, the input may be received at a button, plate, or other discrete location on a vehicle steering wheel inner portion or outer portion. In some instances, the input can be received through a conductive fabric or other conductive material extending around a portion or entire circumference of an outer surface of an outer portion of a steering wheel, or an inner portion of a steering wheel.

The pressure of the input may be translated to a particular input level from a plurality of possible pressures and corresponding input levels. For example, an input touching the surface of the vehicle steering wheel input mechanism may correspond to a first level of input, an input of a slight pressure (i.e., more than merely a surface touch) to the surface of the vehicle steering wheel input mechanism may correspond to a second level of input, and an input applying a firm level of pressure to the surface of the vehicle steering wheel input mechanism may correspond to a third level of input.

The physical characteristics of the pressure may depend on and be tuned to a particular user and designer preference. A first level of input may simply correspond to merely touching the surface of a vehicle steering wheel input mechanism. A firm level of input, or deepest level of input, may correspond to a comfortable but firm pressure that is able to be applied by a thumb, one or more fingers, a palm, or other part of the user's hand on a steering wheel. A light or other intermediary level of pressure can be designed to be somewhere between the surface pressure and firm pressure as applied by a user's finger, thumb, palm, or some other part of a user's hand. The pressures corresponding to the different levels of touch may be set by default, configured by a user, and/or learned by the system over time in response to multiple uses of the input mechanisms by the user (e.g., driver).

In some instances, the user input can be overridden at step 550. The user may apply a high level of pressure to a steering wheel in response to the user's current environment. For example, if an accident or other sudden event occurs in front of the user's vehicle, the sudden event may cause the user to momentarily apply a tightened grip to the steering wheel. If perception data detects an accident or other sudden event in front of the user in the moments before a tightened grip is detected on the steering wheel, the system may decide to ignore the user's tightened grip as an intentional input. In some instances, the system may continue to monitor the level of the user's grip on the steering wheel for moments after the sudden event to determine if the user releases the pressure applied to the steering wheel or if the pressure continues, suggesting the user intends to provide input at the same time as the sudden event occurrence. In some instances, the system will not override a user's pressure related input to the central input mechanism, and will process the input as discussed with respect to step 560. However, the system can update a display when the user releases the pressure applied to the vehicle steering wheel input mechanism.

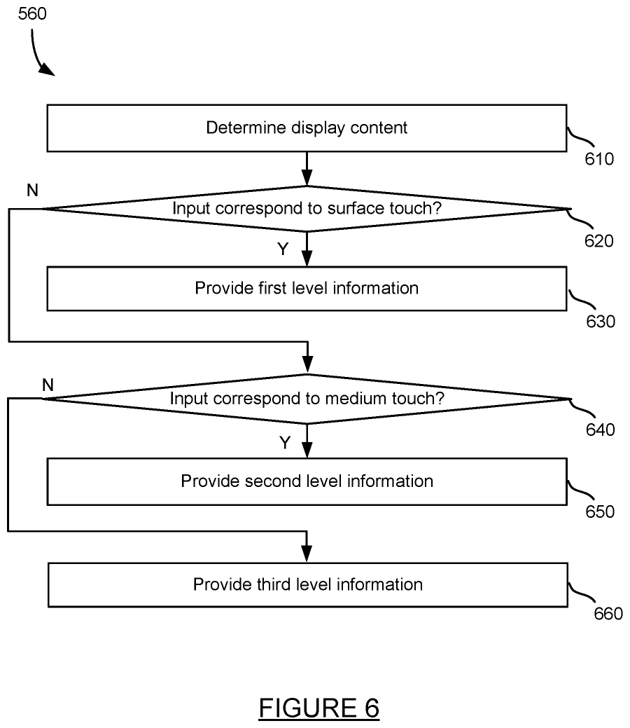

An output is provided within the vehicle based on the detected pressure input level from the steering wheel input mechanism at step 560. Different outputs may be provided on a display or other output mechanism of the vehicle based on the level of input received through the vehicle steering wheel input mechanism. More detail for providing an output based on the detected pressure input level from the steering wheel input mechanism is discussed with respect to the method of FIG. 6.

In some instances, the input received at the steering wheel input mechanisms may control aspects of the car, communications via telephone, or other operations of the vehicle. In this regard, a display, speaker, or other output may confirm that an operation was confirmed, but the sole result of receiving the pressure input corresponding to one of a plurality of detectable pressure inputs will be more than providing selected data on a vehicle display such as an ADAS or augmented reality display of a windshield, side or rear view mirror, or window.

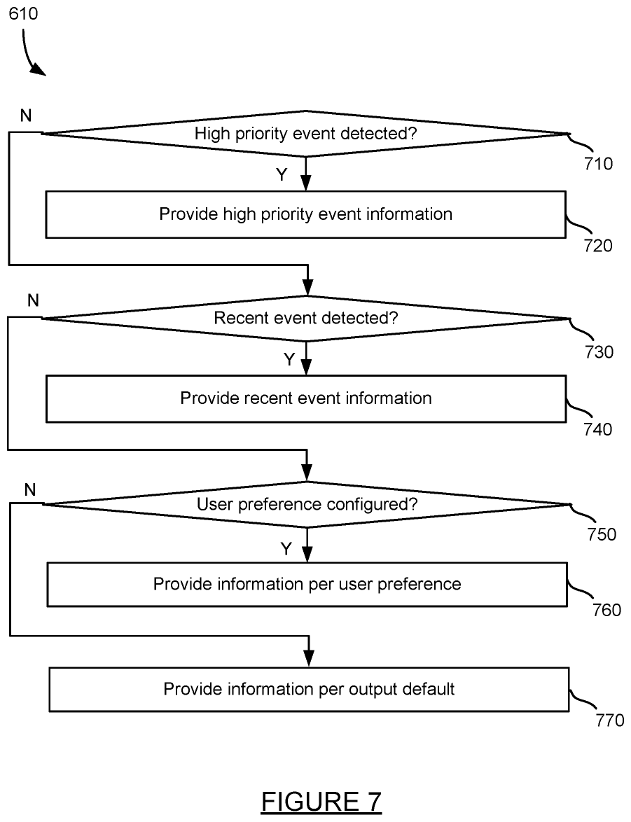

FIG. 6 illustrates a method for providing output based on a detected pressure input double from a steering wheel input mechanism. The method of FIG. 6 provides more detail for step 560 of the method of FIG. 5. First, display content is determined at step 610. The display content determined at step 610 may include content determined from detected events, vehicle operation, user preferences, and default information. More details for determining content to display is discussed with respect to the method of FIG. 7.

The displayed content can be modified based on input received from a user through a steering wheel input mechanism. Depending on the pressure of the input, different levels of information may be provided to a user through an output device of the vehicle, such as for example an ADAS or augmented reality display in a windshield. In the method of FIG. 6, three levels of input are discussed, though more or fewer levels may be implemented.

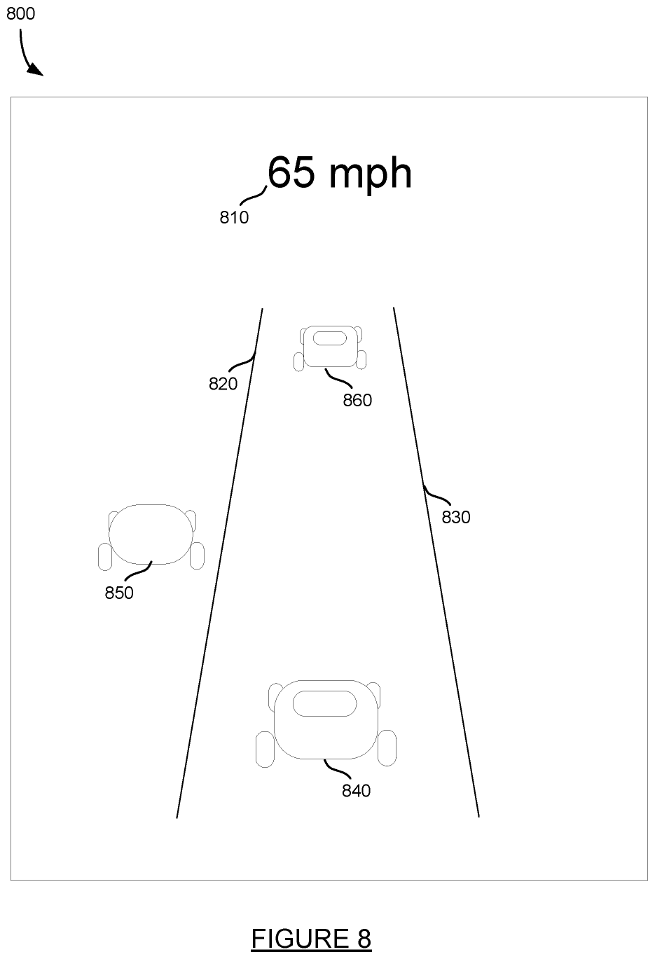

A determination is made as to whether user input corresponds to a surface touch at step 620. If input received from a user at the steering wheel input mechanism corresponds to a surface touch (a touch that is detected but does not cause the input mechanism to be depressed a material amount), then a first level of information is provided at step 630. A first level information may provide a first level of granularity with respect to objects provided in the display. For example, for a route being traveled, the first level of information may be the time remaining until the destination is reached; for a planned lane merge, the first level of information may be a depiction of automobiles near the present vehicle; when the vehicle is low on gas, it may be a location of a nearby gas station. A first level of information provided within a display is discussed with respect to the block diagram of FIG. 8.

If input does not correspond to a surface touch, a determination is made as to whether the input corresponds to a medium level of touch at step 640. A medium level of touch, or any other level of touch, may be calibrated between a surface level of touch and a firm or high-pressure level of touch, with any additional levels equally dispersed in pressure range between the high level of touch and surface touch. If the input corresponds to a medium level of touch, a second level of information is provided in the display at step 650.

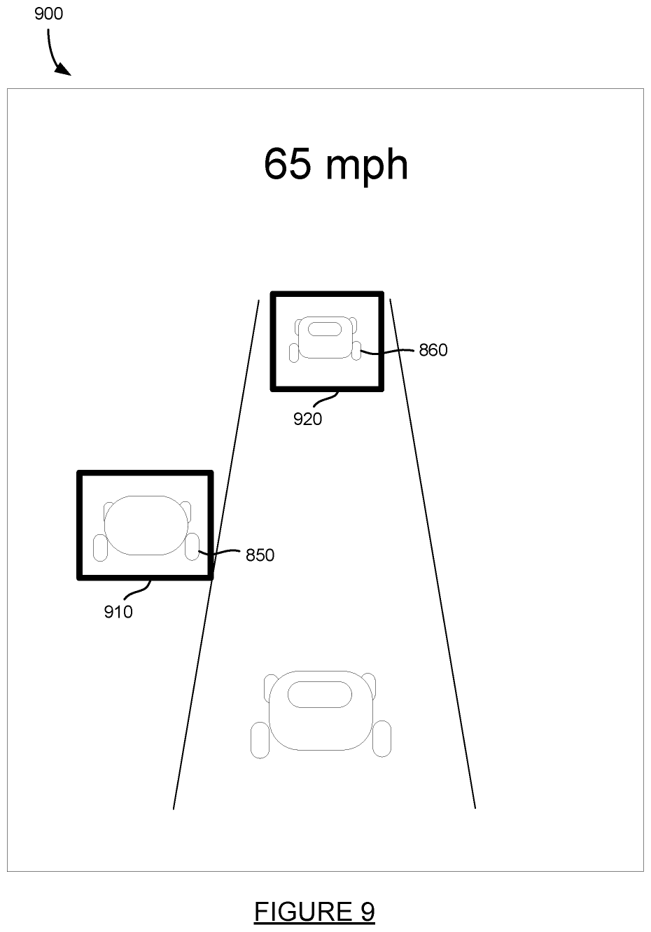

The medium level of touch may correspond to a second level of information being displayed. For example, for a route being traveled, the second level of information may be the parking options available near the destination; for a planned lane merge, the second level of information may be a highlighted illustration of automobiles near the present vehicle; when the vehicle is low on gas, the second level of information may be whether nearby gas station has charging stations. A display with a second level of information is discussed with respect to the block diagram of FIG. 9.

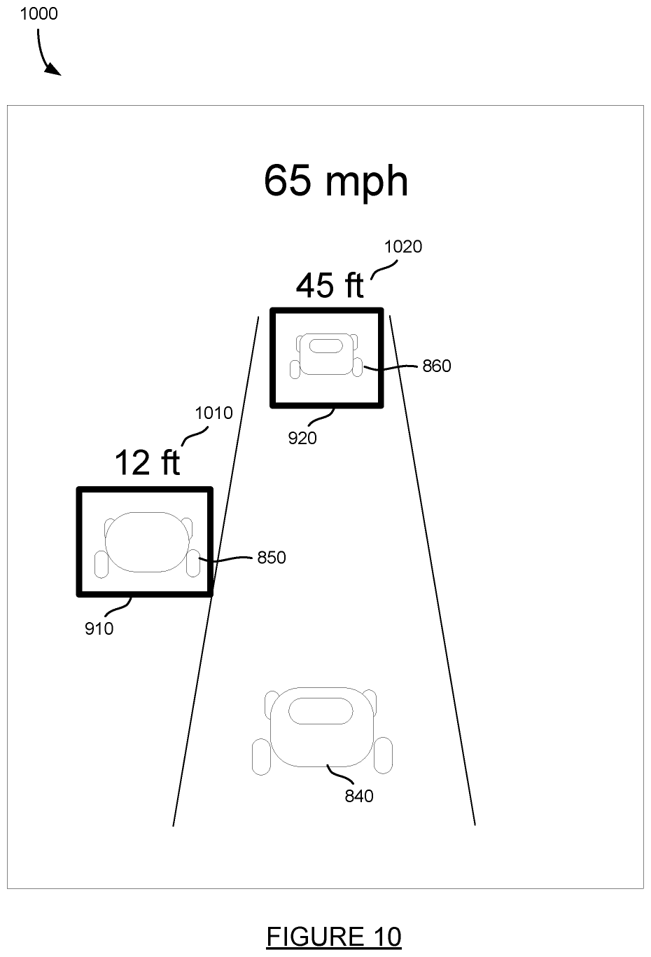

If the input does not correspond to a medium level of touch, then the input is determined to be a firm level of touch at the input mechanism and a third level of information is provided at step 660. For example, for a route being traveled, the third level of information may be the number or parking spaces at parking locations available near the destination; for a planned lane merge, the third level of information may be the distance between external moving automobiles and the present vehicle; when the vehicle is low on gas, the third level of information may be cost of nearby charging stations. A display providing a third level of information is discussed with respect to the block diagram of FIG. 10.

FIG. 7 illustrates a method for determining display content for a vehicle display. The method of FIG. 7 provides more detail for step 610 the method of FIG. 6. First, a determination is made as to whether a high priority event is detected at step 710. A high priority event may include detecting that one or more vehicles that are within a certain threshold distance, such as within 20 feet of the present vehicle. Another example of a high priority event may include a vehicle in the present vehicle's current path that is slowing down, or a detection that other objects such as a pedestrian or bicycle detected to be traveling in a path that will cross the current vehicle's path, a traffic alert, or some other event. If a high priority event is detected, high priority event information may be provided at step 720.

If a high priority event is not detected, then a determination is made as to whether any recent event has been detected at step 730. A recent event may include mapping a current route, turning on the radio, receiving a phone call, or other events. If a recent event has been detected, then recent event information regarding the recent detected event is provided at step 740. If no recent event has been detected, then a determination is made as to whether there is any user preference configured with respect to displaying information at step 750. If there are user preferences, such as for example to provide information relating to the nearest gas station or charge station, the user preferred information is provided on the display per the user preference at step 760. If no user preference is configured, then information is provided on the display according to defaults settings at step 770.

FIG. 8 illustrates a display providing a first level of information in response to receiving a first level of input at a steering wheel input mechanism from a user. The display 800 of FIG. 8 includes traffic lane lines 820 and 830, a present vehicle 840, and other vehicles 850 and 860. It may be determined that vehicle 850 is within a threshold distance of present vehicle 840. As such, vehicle 850 as well as other vehicles, in this case vehicle 860, may be highlighted on the display 800 in response to receiving a first level touch on a steering wheel input mechanism.

FIG. 9 illustrates a display providing a second level of information in response to receiving a second level of input at a steering wheel input mechanism from a user. In response to receiving a second level input at a steering wheel input mechanism, for example in the form of a touch that is firmer than a mere surface touch, highlight boxes may be displayed around objects within the current display. In the display 900 of FIG. 9, display box 910 is displayed around vehicle 850 and display box 920 is displayed around vehicle 860.

FIG. 10 illustrates a display providing a third level of information in response to receiving a third level of input at a steering wheel input mechanism from a user. The third level of information in display 1000 may be provided in response to receiving a firm input at a steering wheel input mechanism. As a result of receiving the third level of input, distance information between the current vehicle and the extra vehicles is provided within the display. In particular, the display is updated to show that external vehicle 850 is 12 feet away from the current vehicle 840 and external vehicle 860 is 45 feet away from the present vehicle 840

FIG. 11 is a block diagram of systems comprising an autonomous vehicle. The autonomous vehicle 1100 of FIG. 11 includes a data processing system 1125 in communication with an inertia measurement unit (IMU) 1105, cameras 1110, radar 1115, lidar 1120, acceleration 1130, steering 1135, braking system 1140, battery system 1145, and propulsion system 1150. The data processing system and the components it communicates with are intended to be exemplary for purposes of discussion. It is not intended to be limiting, and additional elements of an autonomous vehicle may be implemented in a system of the present technology, as will be understood by those of ordinary skill in the art.

IMU 1105 may track and measure the autonomous vehicle acceleration, yaw rate, and other measurements and provide that data to data processing system 1125.

Cameras 1110, radar 1115, and lidar 1120, and optionally other sensors such as microphones, ultrasound, and infrared sensors may form part of a perception component of AV 1110. The autonomous vehicle may include one or more cameras 1110 to capture visual data inside and outside of the autonomous vehicle. On the outside of the autonomous vehicle, multiple cameras may be implemented. For example, cameras on the outside of the vehicle may capture a forward-facing view, a rear facing view, and optionally other views. The cameras may include HD cameras to collect detailed image data of the environment. Images from the cameras may be processed to detect objects such as streetlights, stop signs, lines or borders of one or more lanes of a road, and other aspects of the environment for which an image may be used to better ascertain the nature of an object than radar. To detect the objects, pixels of images are processed to recognize objects, and singular images and series of images. The processing may be performed by image and video detection algorithms, machine learning models which are trained to detect particular objects of interest, and other techniques.

Radar 1115 may include multiple radar sensing systems and devices to detect objects around the autonomous vehicle. In some instances, a radar system may be implemented at one or more of each of the four corners of the vehicle, a front of the vehicle, a rear of the vehicle, and on the left side and right side of the vehicle. The radar elements may be used to detect stationary and moving objects in adjacent lanes as well as in the current lane in front of and behind the autonomous vehicle. Lidar may also be used to detect objects in adjacent lanes, as well as in front of and behind the current vehicle. Other sensors, such as ultrasound, can also be used as part of the AV 1100.

Microphones (not illustrated) may include one or more microphones receive audio content from the external environment and the internal environment. Regarding the external, microphones may pick up sirens, questions, and other cues related to elements of the external environment. The internal environment microphones may be positioned to recognize the user and a driver seat of a vehicle, or in some other position of the vehicle.

Data processing system 1125 may include one or more processors, memory, and instructions stored in memory and executable by the one or more processors to perform the functionality described herein. In some instances, the data processing system may include a planning module, a control module, and a drive-by wire module. The modules communicate with each other to receive data from a perception component, plan actions, and generate commands to execute lane changes.

Acceleration 1130 may receive commands from the data processing system to accelerate the AV. Acceleration 1130 may be implemented as one or more mechanisms to apply acceleration to the propulsion system 1150. Steering module 1135 controls the steering of the vehicle, and may receive commands to steer the AV from data processing system 1125. Brake system 1140 may handle braking applied to the wheels of autonomous vehicle 1100, and may receive commands from data processing system 1125. Battery system 1145 may include a battery, charging control, a battery management system, and other modules and components related to a battery system on an AV. Propulsion system 1150 may manage and control propulsion of the vehicle, and may include components of a combustion engine, electric motor, drivetrain, and other components of a propulsion system utilizing an electric motor with or without a combustion engine.

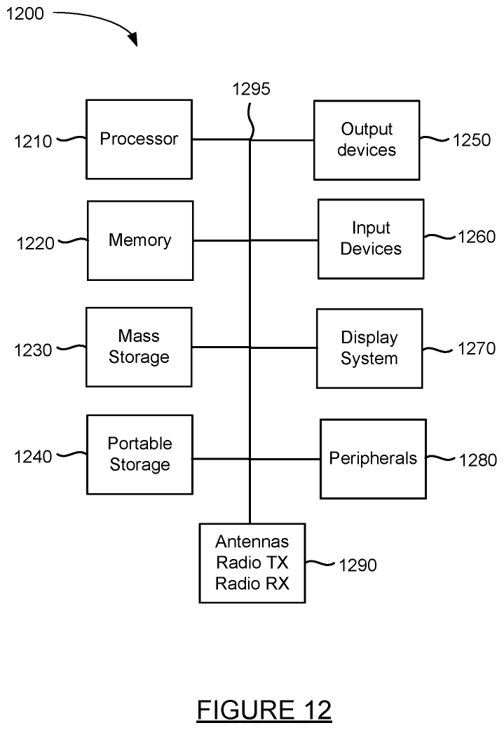

FIG. 12 is a block diagram of a computing environment. System 1200 of FIG. 1200 may be implemented in the contexts of the likes of machines that implement portions of autonomous vehicle system 110, including data processing system 130, and third-party server 170. The computing system 1200 of FIG. 12 includes one or more processors 1210 and memory 1220. Main memory 1220 stores, in part, instructions and data for execution by processor 1210. Main memory 1220 can store the executable code when in operation. The system 1200 of FIG. 12 further includes a mass storage device 1230, portable storage medium drive(s) 1240, output devices 1250, user input devices 1260, a graphics display 1270, and peripheral devices 1280.

The components shown in FIG. 12 are depicted as being connected via a single bus 1290. However, the components may be connected through one or more data transport means. For example, processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive, an optical disk drive, a flash drive, or other device, is a non-volatile storage device for storing data and instructions for use by processor unit 1210. Mass storage device 1230 can store the system software for implementing embodiments of the present invention for purposes of loading that software into main memory 1220.

Portable storage device 1240 operates in conjunction with a portable non-volatile storage medium, such as a floppy disk, compact disk or Digital video disc, USB drive, memory card or stick, or other portable or removable memory, to input and output data and code to and from the computer system 1200 of FIG. 12. The system software for implementing embodiments of the present invention may be stored on such a portable medium and input to the computer system 1200 via the portable storage device 1240.

Input devices 1260 provide a portion of a user interface. Input devices 1260 may include an alpha-numeric keypad, such as a keyboard, for inputting alpha-numeric and other information, a pointing device such as a mouse, a trackball, stylus, cursor direction keys, microphone, touchscreen, accelerometer, and other input devices. Additionally, the system 1200 as shown in FIG. 12 includes output devices 1250. Examples of suitable output devices include speakers, printers, network interfaces, and monitors.

Display system 1270 may include a liquid crystal display (LCD) or other suitable display device. Display system 1270 receives textual and graphical information and processes the information for output to the display device. Display system 1270 may also receive input as a touchscreen.

Peripherals 1280 may include any type of computer support device to add additional functionality to the computer system. For example, peripheral device(s) 1280 may include a modem or a router, printer, and other device.

The system of 1200 may also include, in some implementations, antennas, radio transmitters and radio receivers 1290. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1200 of FIG. 12 are those typically found in computer systems that may be suitable for use with embodiments of the present invention and are intended to represent a broad category of such computer components that are well known in the art. Thus, the computer system 1200 of FIG. 12 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A vehicle steering wheel input mechanism for configuring an output on a vehicle display, comprising:
a steering wheel;
an input mechanism on the steering wheel of a vehicle; a
a data processing system receiving input from the input mechanism and providing an output through a display of the vehicle, the data processing system performing operations to receive a first input initiated from a user through the input mechanism on the steering wheel of the vehicle, the input mechanism having a plurality of input levels, wherein each input level is associated with a different pressure being applied to the surface of the input mechanism on the steering level, the first input received as a first pressure corresponding to the first input level, identifying a subject to provide information through a display, providing a first set of content regarding the identified subject through the display, receiving a second input from the user through the input mechanism on the steering wheel of the vehicle, the second input received as a second pressure corresponding to the second input level, and providing a second set of content regarding the identified subject through the display.

2. The vehicle of claim 1, wherein the subject is identified based on a detection of a high priority event.

3. The vehicle of claim 2, wherein the high priority event includes detecting a low gas level, a blown tire, or a wet road by one or more sensors on the vehicle.

4. The vehicle of claim 1, wherein the subject is identified as a recently detected event.

5. The vehicle of claim 4, wherein the recent event includes a phone call, a car in the path of the vehicle, a navigation event.

6. The vehicle of claim 1, wherein the subject is identified based on a user preference.

7. The vehicle of claim 1, wherein the plurality of input levels includes three input levels corresponding to three different pressures.

8. The vehicle of claim 1, wherein the input mechanism includes a material that covers the outer surface of the steering wheel.

9. The vehicle of claim 8, wherein the input mechanism includes a conductive fabric.

10. The vehicle of claim 8, wherein the input mechanism includes a material made at least in part from conductive strands.

11. A method for configuring an output display of a vehicle using input received from s vehicle steering wheel input mechanism, the method comprising:
receiving a first input from a user through an input mechanism on a steering wheel of a vehicle, the input mechanism having a plurality of input levels, wherein each input level is associated with a different pressure being applied to the surface of the input mechanism on the steering level, the first input received as a first pressure corresponding to the first input level;
identifying a subject to provide information through a display;
providing a first set of content regarding the identified subject through the display;
receiving a second input from the user through the input mechanism on the steering wheel of the vehicle, the second input received as a second pressure corresponding to the second input level; and
providing a second set of content regarding the identified subject through the display.

12. The method of claim 11, wherein the subject is identified based on a detection of a high priority event.

13. The method of claim 12, wherein the high priority event includes detecting a low gas level, a blown tire, or a wet road by one or more sensors on the vehicle.

14. The method of claim 11, wherein the subject is identified as a recently detected event.

15. The method of claim 14, wherein the recent event includes a phone call, a car in the path of the vehicle, a navigation event.

16. The method of claim 11, wherein the subject is identified based on a user preference.

17. The method of claim 11, wherein the plurality of input levels includes three input levels corresponding to three different pressures.

18. The method of claim 11, wherein the input mechanism includes a material that covers the outer surface of the steering wheel.

19. The method of claim 18, wherein the input mechanism includes a conductive fabric.

20. The method of claim 18, wherein the input mechanism includes a material made at least in part from conductive strands.
